(19) United States
(12) Patent Application Publication
(10) Pub. No.: US 2024/0362522 A1
(43) Pub. Date: Oct. 31, 2024

(54) IMPUTING MISSING VALUES IN A DATASET IN THE PRESENCE OF DATA QUALITY DISPARITY

(71) Applicant: International Business Machines Corporation, Armonk, NY (US)

(72) Inventors: Vijay Arya, Gurgaon (IN); Sandeep Hans, New Delhi (IN); Diptikalyan Saha, Bangalore (IN)

(21) Appl. No.: 18/140,130

(22) Filed: Apr. 27, 2023

(51) Int. Cl. G06N 20/00

(52) U.S. Cl. CPC G06N 20/00

(57) ABSTRACT

A computer-implemented method, system and computer program product for imputing missing data in the presence of data quality disparity. An optimization problem of imputing the missing values in the dataset with a presence of data quality disparity is formulated as a black-box optimization problem with an objective of jointly maximining both the fairness metric and an accuracy of the model (machine learning model) trained to identify the missing values to be imputed in the dataset for the sensitive group. Missing values to be imputed in the dataset may then be identified based on maximizing the fairness metric and the accuracy of the model. In this manner, the disparity of the data quality in machine learning datasets involving missing data among sensitive groups is effectively handled.

### TECHNICAL FIELD

The present disclosure relates generally to the disparity of data quality in machine learning datasets, and more particularly to imputing missing values in a dataset (e.g., machine learning dataset) in the presence of data quality disparity based on maximining both a fairness metric and an accuracy of the machine learning model.

### BACKGROUND

Data quality is a measure of the condition of data based on various factors, including completeness. At times, the data includes missing data or missing values, which can occur when there is a lack of data stored for certain variables or participants.

### SUMMARY

In one embodiment of the present disclosure, a computer-implemented method for imputing missing data in the presence of data quality disparity comprises formulating an optimization problem of imputing missing values in a dataset as a black-box optimization problem with an objective of jointly maximizing both a fairness metric and an accuracy of a model. The method further comprises identifying missing values to be imputed in the dataset based on maximizing the fairness metric and the accuracy of the model.

Other forms of the embodiment of the computer-implemented method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 is a diagram of the software components used by the missing data identifier to impute missing data in the presence of data quality disparity in accordance with an embodiment of the present disclosure;

FIG. 3 illustrates an embodiment of the present disclosure of the hardware configuration of the missing data identifier which is representative of a hardware environment for practicing the present disclosure;

FIG. 4 is a flowchart of a method for training a model for imputing missing values in a dataset in the presence of data quality disparity in accordance with an embodiment of the present disclosure; and

FIG. 5 is a flowchart of a method for identifying the missing values to be imputed in the dataset based on maximizing the fairness metric and the accuracy of the trained model in accordance with an embodiment of the present disclosure.

### DETAILED DESCRIPTION

As stated in the Background section, data quality is a measure of the condition of data based on various factors, including completeness. At times, the data includes missing data or missing values, which can occur when there is a lack of data stored for certain variables or participants.

Such data quality, including completeness of the data, may vary in datasets, such as machine learning datasets. In particular, the data quality of such datasets may vary across different “sensitive groups.” A “sensitive group,” as used herein, refers to variables or participants (e.g., privileged versus unprivileged) for which the collected data (e.g., health insurance coverage) may vary. At times, certain sensitive groups may have a greater amount of missing data in the dataset than other sensitive groups. For example, an unprivileged group (e.g., low income participants) may have a greater amount of missing data than a privileged group (e.g., high income participants). Hence, the unprivileged group may be said to have poor quality data; whereas, the privileged group may be said to have high quality data.

Typically, when processing data for machine learning, the rows of data that includes missing values are removed so as to provide the highest quality of data for machine learning. Unfortunately, by removing such low quality data, the sensitive group (e.g., low income participants) associated with such data may be underrepresented or even eliminated from being represented by the dataset. As a result, the machine learning model may learn incorrect representations from the dataset.

For example, the original dataset may contain missing values disproportionately for certain sensitive groups (e.g., low income participants) thereby having what is said to be a “bias” with respect to such sensitive groups. “Bias” refers to having the results not being able to be generalizable, such as for the sensitive group, since the data comes from an unrepresentative sample. By removing such low quality data, such as removing the rows containing missing values, the data is said to be “cleaned.” However, the cleaned data is not only biased with respect to such sensitive groups, but may even be more biased to such sensitive groups since data pertaining to such sensitive groups was removed. When such cleaned data is used to train the machine learning model, the machine learning model may still learn incorrect representations with respect to the original uncleaned data even if the model is trained using machine learning techniques that attempt to remove bias from the cleaned data.

Hence, there is not currently a means for effectively handling the disparity of data quality in machine learning datasets where the quality of data or the amount of missing data varies among sensitive groups.

The embodiments of the present disclosure provide a means for effectively handling the disparity of data quality in machine learning datasets involving missing data among sensitive groups. In one embodiment, an optimization problem of imputing the missing values in the dataset as a black-box optimization problem with an objective of jointly maximining both a fairness metric and an accuracy of a model (machine learning model) is formulated. A “fairness metric,” as used herein, refers to a measure that enables a user to detect the presence of bias in the data or model. “Bias,” in connection with the fairness metric, as used herein, refers to a preference of one group, such as a sensitive group, over another group, implicitly or explicitly. Examples of fairness metrics include, but not limited to, disparate impact, statistical parity difference, equal opportunity difference, etc. For instance, fairness may be maximized by minimizing the disparate impact among sensitive groups. “Accuracy,” as used herein, refers to a fraction of the predictions that the model was correct. For example, accuracy may correspond to the number of correct predictions/total number of predictions. Missing values to be imputed in the dataset may then be identified based on maximizing the fairness metric and the accuracy of the model. These and other features will be discussed in further detail below.

In some embodiments of the present disclosure, the present disclosure comprises a computer-implemented method, system and computer program product for imputing missing data in the presence of data quality disparity. In one embodiment of the present disclosure, an optimization problem of imputing the missing values in the dataset with a presence of data quality disparity is formulated as a black-box optimization problem with an objective of jointly maximining both the fairness metric and an accuracy of the model (machine learning model) trained to identify the missing values to be imputed in the dataset for the sensitive group. Missing values to be imputed in the dataset may then be identified based on maximizing the fairness metric and the accuracy of the model. In one embodiment, the missing values to be imputed in the dataset (e.g., data samples of the dataset for the sensitive group) in the presence of data quality disparity are identified by solving the optimization problem using a black-box optimization technique (e.g., reinforcement learning) which maximizes the fairness metric and the accuracy of the model. In one embodiment, one out of the possible imputation algorithms is selected to identify the missing values to be imputed in the dataset which maximizes the fairness metric and the accuracy of the model. An imputation algorithm, as used herein, refers to an algorithm that substitutes the missing data with a different value while retaining the majority of the dataset's data and information. Examples of such imputation algorithms include, but not limited to, next or previous value, k-nearest neighbors, maximum or minimum value, missing value prediction, most frequent value, average or linear interpolation, (rounded) mean or moving average or median value, fixed value, etc. In this manner, the disparity of the data quality in machine learning datasets involving missing data among sensitive groups is effectively handled.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill the relevant art.

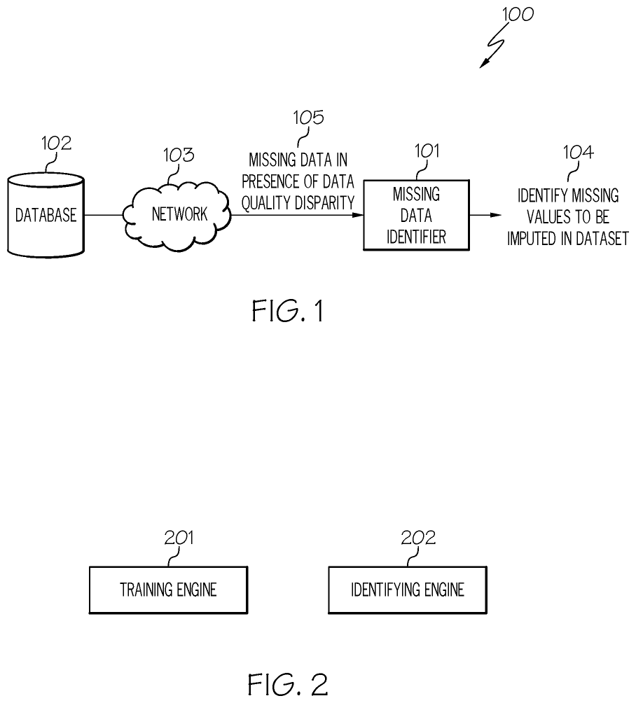

Referring now to the Figures in detail, FIG. 1 illustrates an embodiment of the present disclosure of a communication system 100 for practicing the principles of the present disclosure. Communication system 100 includes a missing data identifier 101 connected to a database 102 via a network 103.

Network 103 may be, for example, a local area network, a wide area network, a wireless wide area network, a circuit-switched telephone network, a Global System for Mobile communications (GSM) network, a Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present disclosure.

In one embodiment, missing data identifier 101 is configured to identify missing values to be imputed in a dataset (see element 104) obtained from database 102, where the received dataset from database 102 includes missing data in the presence of data quality disparity (see element 105).

“Data quality disparity,” as used herein, refers to the quality of the data being different among different sensitive groups. For example, the data quality of a dataset may vary across different sensitive groups. A “sensitive group,” as used herein, refers to variables or participants (e.g., privileged versus unprivileged) for which the collected data (e.g., health insurance coverage) may vary.

In one embodiment, missing data identifier 101 imputes missing data in the presence of data quality disparity by training a model (machine learning model) in the presence of data quality disparity to identify missing values to be imputed in a received dataset (see element 104), where the received dataset includes missing data in the presence of data quality disparity (see element 105). A “model,” as used herein, refers to a machine learning model, which corresponds to a program that can find patterns or make decisions from a previously unseen dataset.

In one embodiment, missing data identifier 101 formulates an optimization problem of imputing the missing values in the dataset as a black-box optimization problem with an objective of jointly maximining both a fairness metric and an accuracy of the trained model (machine learning model). Missing values to be imputed in the dataset may then be identified based on maximizing the fairness metric and the accuracy of the model. These and other features will be discussed in further detail below.

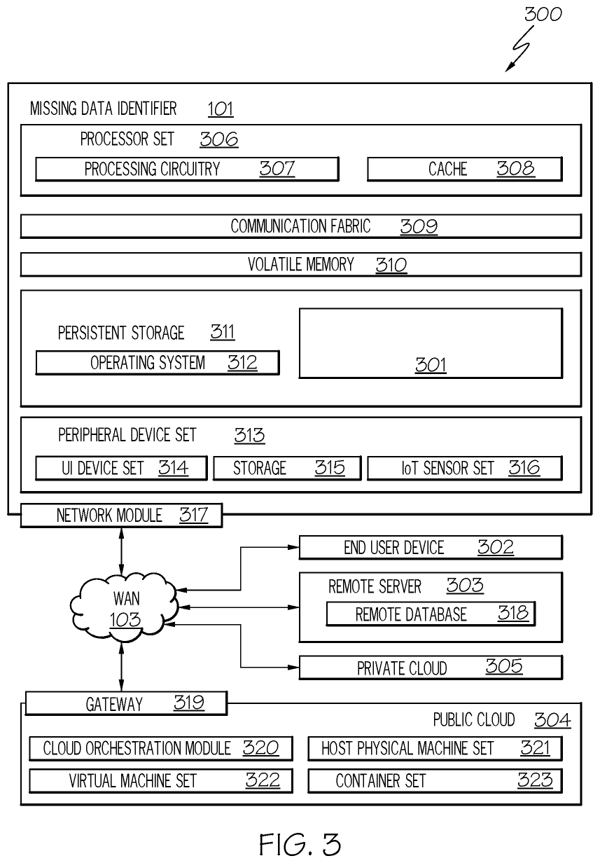

Furthermore, a description of the software components of missing data identifier 101 is provided below in connection with FIG. 2 and a description of the hardware configuration of missing data identifier 101 is provided further below in connection with FIG. 3.

System 100 is not to be limited in scope to any one particular network architecture. System 100 may include any number of missing data identifiers 101, databases 102 and networks 103.

A discussion regarding the software components used by missing data identifier 101 to impute missing data in the presence of data quality disparity is provided below in connection with FIG. 2.

FIG. 2 is a diagram of the software components used by missing data identifier 101 to impute missing data in the presence of data quality disparity in accordance with an embodiment of the present disclosure.

Referring to FIG. 2, in conjunction with FIG. 1, missing data identifier 101 includes a training engine 201 configured to train a model (machine learning model) to impute missing data in the presence of data quality disparity.

In one embodiment, the model is trained by training engine 201 by receiving data samples of the dataset for each sensitive group (e.g., privileged, unprivileged, low-income, high-income, etc.). As discussed above, a “sensitive group,” as used herein, refers to variables or participants (e.g., privileged versus unprivileged) for which the collected data (e.g., health insurance coverage) may vary. In one embodiment, the missing values in the data samples in the dataset for each sensitive group are then imputed by training engine 201 separately using various techniques (e.g., mean, median, mode, weighted mean, etc.). In one embodiment, the missing values in the data samples in the dataset are imputed in the data samples in the dataset for each sensitive group differently. Such an imputation performed by training engine 201 is said to be “bias-aware” imputation.

For example, the mean, median, mode or weighted mean may be utilized to identify the missing values for each sensitive group separately. The “mean,” as used herein, refers to the sum of all of the numbers divided by the number of numbers. The “median,” as used herein, refers to the middle value in a set of data. The “mode,” as used herein, refers to the most frequent number in the dataset. The “weighted mean,” as used herein, is calculated by multiplying the weight (or probability) associated with a particular event or outcome with its associated quantitative outcome and then summing all the products together.

For instance, if the missing values correspond to missing salary values for a sample directed to an unprivileged group, then the mean of all salaries for all the samples directed to the unprivileged group may be used to impute the missing salary value based on the weighted average of the salaries for all the samples directed to the unprivileged group.

In another example, the technique of utilizing the distribution of the non-sensitive attribute for each sensitive group may be utilized by training engine 201 to identify the missing values to be imputed in the data samples of the dataset for each sensitive group. For example, learn distributions of salary (non-sensitive attribute) for the privileged and unprivileged groups (sensitive groups) may be utilized to identify the missing values to be imputed in the data samples of the dataset for each sensitive group. For instance, a value may be chosen at random from the salary distribution for the unprivileged sensitive group for imputing a missing salary value in a row of data for the unprivileged sensitive group.

In one embodiment, training engine 201 trains the model using sample weights corresponding to the data samples with the imputed missing values jointly weighed based on data quality and data bias.

For example, rows in the dataset can be jointly weighed as follows. Let W_{privileged} and W_{unprivileged} be the original weights assigned to each privileged and unprivileged row based on fairness. For example, such weights may be based on the probability of the samples within such a sensitive group being misclassified. In one embodiment, such weights are assigned by an expert. Furthermore, the data quality weights of k rows from the privileged sensitive group is q₁, q₂, . . . , qₖ, s.t. qᵢ∈[0, 1].

In one embodiment, these weights are normalized so that:

$${\sum }_{i} {q}_{i} = 1$$

Next, weight is assigned to row i as qᵢkW_{privileged}.

In one embodiment, the weights, qᵢ, are obtained by using the confidence or uncertainty score of all the imputed values in a row. In one embodiment, for the rows with no imputed values, qᵢ is set to equal 1.

In one embodiment, the above procedure ensures that the aggregate weight of the rows in the data samples of the sensitive groups (e.g., privileged, unprivileged) remains the same.

In one embodiment, the sample weights are used to weigh the terms in a loss function of the model. The loss function evaluates how well the model predicts the missing values to be imputed in the dataset, such as the data samples of the dataset for a sensitive group. Examples of such a loss function include a squared-error loss, mean squared error, mean absolute error, Huber loss, etc.

In one embodiment, training engine 201 trains each model for each sensitive group to predict the missing value of a feature. For example, a model (e.g., regression) for each sensitive group (e.g., privileged, unprivileged) is trained with salary as a label, where such models are used for predicting the missing salary value. “Label,” as used herein, refers to what is being predicted, such as the missing value of a feature in a data sample of the dataset directed to a sensitive group. If the model is a decision or a directly interpretable model, it may be used to obtain explanations of imputed values.

In one embodiment, training engine 201 uses a machine learning algorithm to build and train a model (machine learning model) to impute the missing data in the presence of data quality disparity based on maximizing a fairness metric and accuracy of the model. A “fairness metric,” as used herein, refers to a measure that enables a user to detect the presence of bias in the data or model. “Maximizing a fairness metric,” as used herein, refers to achieving the greatest overall fairness of the model, which may include minimizing the fairness metric itself, such as minimizing the disparate impact (discussed further below). “Bias,” in connection with the fairness metric, as used herein, refers to a preference of one group, such as a sensitive group, over another group, implicitly or explicitly. Examples of fairness metrics include, but not limited to, disparate impact, statistical parity difference, equal opportunity difference, etc.

“Disparate impact,” as used herein, refers to a metric that compares the percentage of favorable outcomes for a monitored group to the percentage of favorable outcomes for a reference group. As a result, maximizing the fairness metric of a disparate impact corresponds to minimizing the disparate impact.

In one embodiment, the following formula is used for calculating disparate impact:

$$Disparate impact = \frac{( num\_positives ( privileged = False ) / num\_instances ( privileged = False ) )}{( num\_positives ( privileged = True ) / num\_instances ( privileged = True ) )}$$

The num_positives value represents the number of individuals in the group who received a positive outcome, and the num_instances value represents the total number of individuals in the group. The privileged=False label specifies unprivileged groups and the privileged=True label specifies privileged groups. In one embodiment, training engine 201 uses Watson OpenScale®, where the positive outcomes are designated as the favorable outcomes, and the negative outcomes are designated as the unfavorable outcomes. In one embodiment, the privileged group is designated as the reference group, and the unprivileged group is designated as the monitored group.

“Statistical parity difference,” as used herein, calculates the difference in the ratio of favorable outcomes between the monitored groups and the reference groups. That is, the statistical parity difference is a fairness metric that describes the fairness for the model predictions. It is the difference between the ratio of favorable outcomes in the monitored and reference groups. When the value of the statistical parity difference is under 0, there is a higher benefit for the monitored group. When the value of the statistical parity difference is 0, both groups have equal benefit. When the value of the statistical parity difference is over 0, it implies that there is a higher benefit for the reference group. In one embodiment, the following formula may be used for calculating the statistical parity difference (SPD):

$$\frac{num\_positives ( privileged = False )}{num\_instances ( privileged = False )} - \frac{num\_positives ( privileged = True )}{num\_instances ( privileged = True )}$$

“Equal Opportunity Difference,” as used herein, refers to the difference in equal opportunity. “Equal opportunity,” as used herein, refers to having each group obtain a positive outcome at equal rates, assuming that those in the group qualify for it.

“Accuracy,” as used herein, refers to a fraction of the predictions that the model was correct. For example, accuracy may correspond to the number of correct predictions/total number of predictions.

Missing values to be imputed in the dataset may then be identified based on maximizing the fairness metric and the accuracy of the model.

In one embodiment, the model (machine learning model) is built and trained using a sample data set that includes the missing values of the data samples of the dataset based on maximizing a fairness metric (e.g., minimizing the disparate impact) and accuracy of the model. For example, such a sample data set may include various missing values of the data samples of the dataset based on fairness metric values and accuracy scores of the model. In one embodiment, such a sample data set is compiled by an expert.

Furthermore, such a sample data set is referred to herein as the “training data,” which is used by the machine learning algorithm to make predictions or decisions as to the missing values to be imputed in the data samples of the dataset for a sensitive group based on maximizing a fairness metric (e.g., minimizing the disparate impact) and accuracy of the model. The algorithm iteratively makes predictions of the imputed missing values until the predictions achieve the desired accuracy as determined by an expert. Examples of such learning algorithms include nearest neighbor, Naïve Bayes, decision trees, linear regression, support vector machines and neural networks.

In one embodiment, maximizing the fairness metric and the accuracy of the model may be represented mathematically as follows:

λ₁S+λ₂I
where S corresponds to the accuracy score of the model, I corresponds to the value of the fairness metric and λ₁, λ₂ are weights for the accuracy score and the value of the fairness metric, respectively, as established by an expert. Alternatively, the above objective function may be formulated as λ₁S−λ₂I. For instance, if “I” was the disparate impact, then fairness is maximized by minimizing the disparate impact. Therefore, the above objective function can also be formulated as λ₁S−λ₂I. In one embodiment, the maximizing of such an objective may be subject to various constraints, such as the imputation constraints and the perturbation constraint, thereby restricting the range of imputed values of a variable so that they are plausible. The imputation constraints correspond to the constraints for the features, such as the minimum or maximum distance from the mean, etc. The perturbation (deviation) constraint corresponds to having the dissimilarity (d(D₁), d(D₂))≤ω, where D₁ and D₂ are distributions of data and ω is a user-defined threshold value. That is, the empirical distribution of D₁ and D₂ are not too far from one another. For example, if there are three features (f₁, f₂ and f₃) and a target (y), with f₁ as the sensitive attribute, then the distribution of (f₂, f₃, Y)_{D1} is compared with the distribution of (f₂, f₃, Y)_{D2}.

After training the model, identifying engine 202 of missing data identifier 101 utilizes the trained model for imputing missing data in the dataset (e.g., missing values in the data samples of the dataset for a sensitive group) in the presence of data quality disparity.

In one embodiment, identifying engine 202 formulates an optimization problem of imputing the missing values in the dataset as a black-box optimization problem with an objective of jointly maximining both the fairness metric and an accuracy of the trained model (machine learning model).

As discussed above, a “fairness metric,” as used herein, refers to a measure that enables a user to detect the presence of bias in the data or model. “Bias,” in connection with the fairness metric, as used herein, refers to a preference of one group, such as a sensitive group, over another group, implicitly or explicitly. Examples of fairness metrics include, but not limited to, disparate impact, statistical parity difference, equal opportunity difference, etc. For instance, fairness may be maximized by minimizing the disparate impact among sensitive groups. “Accuracy,” as used herein, refers to a fraction of the predictions that the model was correct. For example, accuracy may correspond to the number of correct predictions/total number of predictions. Missing values to be imputed in the dataset may then be identified based on maximizing the fairness metric and the accuracy of the model.

“Black box optimization,” as used herein, refers to a problem setup in which an optimization algorithm is supposed to optimize an objective function through a so-called black-box interface. For example, the algorithm may query the value f(x) for a point x, but it does not obtain gradient information, and in particular, it cannot make any assumptions on the analytic form of f (e.g., being linear or quadratic). Such an objective function may be thought as being wrapped in a black box. The goal of optimization is to find an as good as possible value f(x) within a predefined time, often defined by the number of available queries to the black box.

In one embodiment, the black-box optimization problem is solved by identifying engine 202 using a black-box optimization technique, such as reinforcement learning, to solve the optimization problem using the trained model to impute missing values.

In one embodiment, the missing values are modeled as hyperparameters in the trained model. Hyperparameters, as used herein, refer to parameters whose values control the learning process and determine the values of the model parameters that a learning algorithm ends up learning. In one embodiment, identifying engine 202 identifies the missing values to be imputed in the dataset (e.g., data samples of the dataset for the sensitive group) by solving the black-box optimization problem with the missing values modeled as hyperparameters using various software tools, including, but not limited to, Google® Vizier, NOMAD®, etc.

In one embodiment, identifying engine 202 identifies the missing values to be imputed in the dataset (e.g., data samples of the dataset for the sensitive group) in the presence of data quality disparity by solving the optimization problem using the black-box optimization technique to identify the missing values to be imputed in the dataset which maximizes the fairness metric and the accuracy of the model.

In one embodiment, identifying engine 202 identifies the missing values to be imputed in the dataset (e.g., data samples of the dataset for the sensitive group) in the presence of data quality disparity by selecting one of the possible imputation algorithms to identify the missing values to be imputed in the dataset which maximizes the fairness metric and the accuracy of the model. An imputation algorithm, as used herein, refers to an algorithm that substitutes the missing data with a different value while retaining the majority of the dataset's data and information. Examples of such imputation algorithms include, but not limited to, next or previous value, k-nearest neighbors, maximum or minimum value, missing value prediction, most frequent value, average or linear interpolation, (rounded) mean or moving average or median value, fixed value, etc.

A further description of these and other features is provided below in connection with the discussion of the method for imputing missing data in a dataset in the presence of data quality disparity.

Prior to the discussion of the method for imputing missing data in a dataset in the presence of data quality disparity, a description of the hardware configuration of missing data identifier 101 (FIG. 1) is provided below in connection with FIG. 3.

Referring now to FIG. 3, in conjunction with FIG. 1, FIG. 3 illustrates an embodiment of the present disclosure of the hardware configuration of missing data identifier 101 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 300 contains an example of an environment for the execution of at least some of the computer code (stored in block 301) involved in performing the inventive methods, such as imputing missing data in a dataset in the presence of data quality disparity. In addition to block 301, computing environment 300 includes, for example, missing data identifier 101, network 103, such as a wide area network (WAN), end user device (EUD) 302, remote server 303, public cloud 304, and private cloud 305. In this embodiment, missing data identifier 101 includes processor set 306 (including processing circuitry 307 and cache 308), communication fabric 309, volatile memory 310, persistent storage 311 (including operating system 312 and block 301, as identified above), peripheral device set 313 (including user interface (UI) device set 314, storage 315, and Internet of Things (IoT) sensor set 316), and network module 317. Remote server 303 includes remote database 318. Public cloud 304 includes gateway 319, cloud orchestration module 320, host physical machine set 321, virtual machine set 322, and container set 323.

Missing data identifier 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 318. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically missing data identifier 101, to keep the presentation as simple as possible. Missing data identifier 101 may be located in a cloud, even though it is not shown in a cloud in FIG. 3. On the other hand, missing data identifier 101 is not required to be in a cloud except to any extent as may be affirmatively indicated.

Processor set 306 includes one, or more, computer processors of any type now known or to be developed in the future. Processing circuitry 307 may be distributed over multiple packages, for example, multiple, coordinated integrated circuit chips. Processing circuitry 307 may implement multiple processor threads and/or multiple processor cores. Cache 308 is memory that is located in the processor chip package(s) and is typically used for data or code that should be available for rapid access by the threads or cores running on processor set 306. Cache memories are typically organized into multiple levels depending upon relative proximity to the processing circuitry. Alternatively, some, or all, of the cache for the processor set may be located “off chip.” In some computing environments, processor set 306 may be designed for working with qubits and performing quantum computing.

Computer readable program instructions are typically loaded onto missing data identifier 101 to cause a series of operational steps to be performed by processor set 306 of missing data identifier 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 308 and the other storage media discussed below. The program instructions, and associated data, are accessed by processor set 306 to control and direct performance of the inventive methods. In computing environment 300, at least some of the instructions for performing the inventive methods may be stored in block 301 in persistent storage 311.

Communication fabric 309 is the signal conduction paths that allow the various components of missing data identifier 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 310 is any type of volatile memory now known or to be developed in the future. Examples include dynamic type random access memory (RAM) or static type RAM. Typically, the volatile memory is characterized by random access, but this is not required unless affirmatively indicated. In missing data identifier 101, the volatile memory 310 is located in a single package and is internal to missing data identifier 101, but, alternatively or additionally, the volatile memory may be distributed over multiple packages and/or located externally with respect to missing data identifier 101.

Persistent Storage 311 is any form of non-volatile storage for computers that is now known or to be developed in the future. The non-volatility of this storage means that the stored data is maintained regardless of whether power is being supplied to missing data identifier 101 and/or directly to persistent storage 311. Persistent storage 311 may be a read only memory (ROM), but typically at least a portion of the persistent storage allows writing of data, deletion of data and re-writing of data. Some familiar forms of persistent storage include magnetic disks and solid state storage devices. Operating system 312 may take several forms, such as various known proprietary operating systems or open source Portable Operating System Interface type operating systems that employ a kernel. The code included in block 301 typically includes at least some of the computer code involved in performing the inventive methods.

Peripheral device set 313 includes the set of peripheral devices of missing data identifier 101. Data communication connections between the peripheral devices and the other components of missing data identifier 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 314 may include components such as a display screen, speaker, microphone, wearable devices (such as goggles and smart watches), keyboard, mouse, printer, touchpad, game controllers, and haptic devices. Storage 315 is external storage, such as an external hard drive, or insertable storage, such as an SD card. Storage 315 may be persistent and/or volatile. In some embodiments, storage 315 may take the form of a quantum computing storage device for storing data in the form of qubits. In embodiments where missing data identifier 101 is required to have a large amount of storage (for example, where missing data identifier 101 locally stores and manages a large database) then this storage may be provided by peripheral storage devices designed for storing very large amounts of data, such as a storage area network (SAN) that is shared by multiple, geographically distributed computers. IoT sensor set 316 is made up of sensors that can be used in Internet of Things applications. For example, one sensor may be a thermometer and another sensor may be a motion detector.

Network module 317 is the collection of computer software, hardware, and firmware that allows missing data identifier 101 to communicate with other computers through WAN 103. Network module 317 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 317 are performed on the same physical hardware device. In other embodiments (for example, embodiments that utilize software-defined networking (SDN)), the control functions and the forwarding functions of network module 317 are performed on physically separate devices, such that the control functions manage several different network hardware devices. Computer readable program instructions for performing the inventive methods can typically be downloaded to missing data identifier 101 from an external computer or external storage device through a network adapter card or network interface included in network module 317.

WAN 103 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 302 is any computer system that is used and controlled by an end user (for example, a customer of an enterprise that operates missing data identifier 101), and may take any of the forms discussed above in connection with missing data identifier 101. EUD 302 typically receives helpful and useful data from the operations of missing data identifier 101. For example, in a hypothetical case where missing data identifier 101 is designed to provide a recommendation to an end user, this recommendation would typically be communicated from network module 317 of missing data identifier 101 through WAN 103 to EUD 302. In this way, EUD 302 can display, or otherwise present, the recommendation to an end user. In some embodiments, EUD 302 may be a client device, such as thin client, heavy client, mainframe computer, desktop computer and so on.

Remote server 303 is any computer system that serves at least some data and/or functionality to missing data identifier 101. Remote server 303 may be controlled and used by the same entity that operates missing data identifier 101. Remote server 303 represents the machine(s) that collect and store helpful and useful data for use by other computers, such as missing data identifier 101. For example, in a hypothetical case where missing data identifier 101 is designed and programmed to provide a recommendation based on historical data, then this historical data may be provided to missing data identifier 101 from remote database 318 of remote server 303.

Public cloud 304 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 304 is performed by the computer hardware and/or software of cloud orchestration module 320. The computing resources provided by public cloud 304 are typically implemented by virtual computing environments that run on various computers making up the computers of host physical machine set 321, which is the universe of physical computers in and/or available to public cloud 304. The virtual computing environments (VCEs) typically take the form of virtual machines from virtual machine set 322 and/or containers from container set 323. It is understood that these VCEs may be stored as images and may be transferred among and between the various physical machine hosts, either as images or after instantiation of the VCE. Cloud orchestration module 320 manages the transfer and storage of images, deploys new instantiations of VCEs and manages active instantiations of VCE deployments. Gateway 319 is the collection of computer software, hardware, and firmware that allows public cloud 304 to communicate through WAN 103.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 305 is similar to public cloud 304, except that the computing resources are only available for use by a single enterprise. While private cloud 305 is depicted as being in communication with WAN 103 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 304 and private cloud 305 are both part of a larger hybrid cloud.

Block 301 further includes the software components discussed above in connection with FIG. 2 to impute missing data in a dataset in the presence of data quality disparity. In one embodiment, such components may be implemented in hardware. The functions discussed above performed by such components are not generic computer functions. As a result, missing data identifier 101 is a particular machine that is the result of implementing specific, non-generic computer functions.

In one embodiment, the functionality of such software components of missing data identifier 101, including the functionality for imputing missing data in a dataset in the presence of data quality disparity, may be embodied in an application specific integrated circuit.

As stated above, data quality, including completeness of the data, may vary in datasets, such as machine learning datasets. In particular, the data quality of such datasets may vary across different “sensitive groups.” A “sensitive group,” as used herein, refers to variables or participants (e.g., privileged versus unprivileged) for which the collected data (e.g., health insurance coverage) may vary. At times, certain sensitive groups may have a greater amount of missing data in the dataset than other sensitive groups. For example, an unprivileged group (e.g., low income participants) may have a greater amount of missing data than a privileged group (e.g., high income participants). Hence, the unprivileged group may be said to have poor quality data; whereas, the privileged group may be said to have high quality data. Typically, when processing data for machine learning, the rows of data that includes missing values are removed so as to provide the highest quality of data for machine learning. Unfortunately, by removing such low quality data, the sensitive group (e.g., low income participants) associated with such data may be underrepresented or even eliminated from being represented by the dataset. As a result, the machine learning model may learn incorrect representations from the dataset. For example, the original dataset may contain missing values disproportionately for certain sensitive groups (e.g., low income participants) thereby having what is said to be a “bias” with respect to such sensitive groups. “Bias” refers to having the results not being able to be generalizable, such as for the sensitive group, since the data comes from an unrepresentative sample. By removing such low quality data, such as removing the rows containing missing values, the data is said to be “cleaned.” However, the cleaned data is not only biased with respect to such sensitive groups, but may even be more biased to such sensitive groups since data pertaining to such sensitive groups was removed. When such cleaned data is used to train the machine learning model, the machine learning model may still learn incorrect representations with respect to the original uncleaned data even if the model is trained using machine learning techniques that attempt to remove bias from the cleaned data. Hence, there is not currently a means for effectively handling the disparity of data quality in machine learning datasets where the quality of data or the amount of missing data varies among sensitive groups.

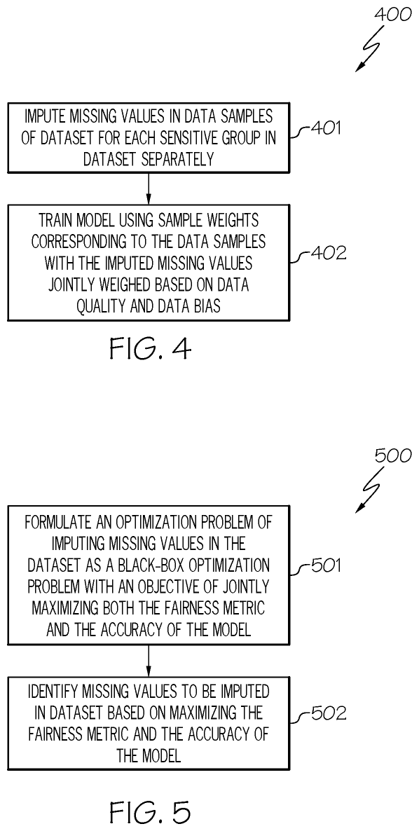

The embodiments of the present disclosure provide a means for effectively handling the disparity of data quality in machine learning datasets involving missing data among sensitive groups as discussed below in connection with FIGS. 4 and 5. FIG. 4 is a flowchart of a method for training a model for imputing missing values in a dataset in the presence of data quality disparity. FIG. 5 is a flowchart of a method for identifying the missing values to be imputed in the dataset based on maximizing the fairness metric and accuracy of the trained model.

As stated above, FIG. 4 is a flowchart of a method 400 for training a model for imputing missing values in a dataset in the presence of data quality disparity in accordance with an embodiment of the present disclosure.

Referring to FIG. 4, in conjunction with FIGS. 1-3, in step 401, training engine 201 of missing data identifier 101 imputes the missing values in data samples of a dataset for each sensitive group (e.g., privileged group, unprivileged group) in the dataset separately.

As discussed above, in one embodiment, the model is trained by training engine 201 by receiving data samples of the dataset for each sensitive group (e.g., privileged, unprivileged, low-income, high-income, etc.). As discussed above, a “sensitive group,” as used herein, refers to variables or participants (e.g., privileged versus unprivileged) for which the collected data (e.g., health insurance coverage) may vary. In one embodiment, the missing values in the data samples in the dataset for each sensitive group are then imputed by training engine 201 separately using various techniques (e.g., mean, median, mode, weighted mean, etc.). In one embodiment, the missing values in the data samples in the dataset are imputed in the data samples in the dataset for each sensitive group differently. Such an imputation performed by training engine 201 is said to be “bias-aware” imputation.

For example, the mean, median, mode or weighted mean may be utilized to identify the missing values for each sensitive group separately. The “mean,” as used herein, refers to the sum of all of the numbers divided by the number of numbers. The “median,” as used herein, refers to the middle value in a set of data. The “mode,” as used herein, refers to the most frequent number in the dataset. The “weighted mean,” as used herein, is calculated by multiplying the weight (or probability) associated with a particular event or outcome with its associated quantitative outcome and then summing all the products together.

For instance, if the missing values correspond to missing salary values for a sample directed to an unprivileged group, then the mean of all salaries for all the samples directed to the unprivileged group may be used to impute the missing salary value based on the weighted average of the salaries for all the samples directed to the unprivileged group.

In another example, the technique of utilizing the distribution of the non-sensitive attribute for each sensitive group may be utilized by training engine 201 to identify the missing values to be imputed in the data samples of the dataset for each sensitive group. For example, learn distributions of salary (non-sensitive attribute) for the privileged and unprivileged groups (sensitive groups) may be utilized to identify the missing values to be imputed in the data samples of the dataset for each sensitive group. For instance, a value may be chosen at random from the salary distribution for the unprivileged sensitive group for imputing a missing salary value in a row of data for the unprivileged sensitive group.

In step 402, training engine 201 of missing data identifier 101 trains the model (machine learning model) using sample weights corresponding to the data samples with the imputed missing values jointly weighed based on data quality and data bias.

As stated above, for example, rows in the dataset can be jointly weighed as follows. Let W privileged and W_{unprivileged} be the original weights assigned to each privileged and unprivileged row based on fairness. For example, such weights may be based on the probability of the samples within such a sensitive group being misclassified. In one embodiment, such weights are assigned by an expert. Furthermore, the data quality weights of k rows from the privileged sensitive group is q₁, q₂, . . . , qₖ, s.t. qᵢ∈[0, 1].

In one embodiment, these weights are normalized so that:

$${\sum }_{i} {q}_{i} = 1$$

Next, weight is assigned to row i as qikW_{privileged}.

In one embodiment, the weights, qᵢ, are obtained by using the confidence or uncertainty score of all imputed values in a row. In one embodiment, for the rows with no imputed values, qᵢ is set to equal 1.

In one embodiment, the above procedure ensures that the aggregate weight of the rows in the data samples of the sensitive groups (e.g., privileged, unprivileged) remains the same.

In one embodiment, the sample weights are used to weigh the terms in a loss function of the model. The loss function evaluates how well the model predicts the missing values to be imputed in the dataset, such as the data samples of the dataset for a sensitive group. Examples of such a loss function include a squared-error loss, mean squared error, mean absolute error, Huber loss, etc.

In one embodiment, training engine 201 trains each model for each sensitive group to predict the missing value of a feature. For example, a model (e.g., regression) for each sensitive group (e.g., privileged, unprivileged) is trained with salary as a label, where such models are used for predicting the missing salary value. “Label,” as used herein, refers to what is being predicted, such as the missing value of a feature in a data sample of the dataset directed to a sensitive group. If the model is a decision or a directly interpretable model, it may be used to obtain explanations of imputed values.

In one embodiment, training engine 201 uses a machine learning algorithm to build and train a model (machine learning model) to impute the missing data in the presence of data quality disparity based on maximizing a fairness metric and accuracy of the model. A “fairness metric,” as used herein, refers to a measure that enables a user to detect the presence of bias in the data or model. “Maximizing a fairness metric,” as used herein, refers to achieving the greatest overall fairness of the model, which may include minimizing the fairness metric itself, such as minimizing the disparate impact (discussed further below). “Bias,” in connection with the fairness metric, as used herein, refers to a preference of one group, such as a sensitive group, over another group, implicitly or explicitly. Examples of fairness metrics include, but not limited to, disparate impact, statistical parity difference, equal opportunity difference, etc.

“Disparate impact,” as used herein, refers to a metric that compares the percentage of favorable outcomes for a monitored group to the percentage of favorable outcomes for a reference group. As a result, maximizing the fairness metric of a disparate impact corresponds to minimizing the disparate impact.

In one embodiment, the following formula is used for calculating disparate impact:

$$Disparate impact = \frac{( num\_positives ( privileged = False ) / num\_instances ( privileged = False ) )}{( num\_positives ( privileged = True ) / num\_instances ( privileged = True ) )}$$

The num_positives value represents the number of individuals in the group who received a positive outcome, and the num_instances value represents the total number of individuals in the group. The privileged=False label specifies unprivileged groups and the privileged=True label specifies privileged groups. In one embodiment, training engine 201 uses Watson OpenScale®, where the positive outcomes are designated as the favorable outcomes, and the negative outcomes are designated as the unfavorable outcomes. In one embodiment, the privileged group is designated as the reference group, and the unprivileged group is designated as the monitored group.

“Statistical parity difference,” as used herein, calculates the difference in the ratio of favorable outcomes between the monitored groups and the reference groups. That is, the statistical parity difference is a fairness metric that describes the fairness for the model predictions. It is the difference between the ratio of favorable outcomes in the monitored and reference groups. When the value of the statistical parity difference is under 0, there is a higher benefit for the monitored group. When the value of the statistical parity difference is 0, both groups have equal benefit. When the value of the statistical parity difference is over 0, it implies that there is a higher benefit for the reference group. In one embodiment, the following formula may be used for calculating the statistical parity difference (SPD):

$$\frac{num\_positives ( privileged = False )}{num\_instances ( privileged = False )} - \frac{num\_positives ( privileged = True )}{num\_instances ( privileged = True )}$$

“Equal Opportunity Difference,” as used herein, refers to the difference in equal opportunity. “Equal opportunity,” as used herein, refers to having each group obtaining a positive outcome at equal rates, assuming that those in the group qualify for it.

“Accuracy,” as used herein, refers to a fraction of the predictions that the model was correct. For example, accuracy may correspond to the number of correct predictions/total number of predictions.

Missing values to be imputed in the dataset may then be identified based on maximizing the fairness metric and the accuracy of the model.

In one embodiment, the model (machine learning model) is built and trained using a sample data set that includes the missing values of the data samples of the dataset based on maximizing a fairness metric (e.g., minimizing the disparate impact) and accuracy of the model. For example, such a sample data set may include various missing values of the data samples of the dataset based on fairness metric values and accuracy scores of the model. In one embodiment, such a sample data set is compiled by an expert.

Furthermore, such a sample data set is referred to herein as the “training data,” which is used by the machine learning algorithm to make predictions or decisions as to the missing values to be imputed in the data samples of the dataset for a sensitive group based on maximizing a fairness metric (e.g., minimizing the disparate impact) and accuracy of the model. The algorithm iteratively makes predictions of the imputed missing values until the predictions achieve the desired accuracy as determined by an expert. Examples of such learning algorithms include nearest neighbor, Naïve Bayes, decision trees, linear regression, support vector machines and neural networks.

In one embodiment, maximizing the fairness metric and the accuracy of the model may be represented mathematically as follows:

λ₁S+λ₂I
where S corresponds to the accuracy score of the model, I corresponds to the value of the fairness metric and λ₁, λ₂ are weights for the accuracy score and the value of the fairness metric, respectively, as established by an expert. Alternatively, the above objective function may be formulated as λ₁S−λ₂I. For instance, if “I” was the disparate impact, then fairness is maximized by minimizing the disparate impact. Therefore, the above objective function can also be formulated as λ₁S−λ₂I. In one embodiment, the maximizing of such an objective may be subject to various constraints, such as the imputation constraints and the perturbation constraint, thereby restricting the range of imputed values of a variable so that they are plausible. The imputation constraints correspond to the constraints for the features, such as the minimum or maximum distance from the mean, etc. The perturbation (deviation) constraint corresponds to having the dissimilarity (d(D₁), d(D₂))≤ω, where D₁ and D₂ are distributions of data and @ is a user-defined threshold value. That is, the empirical distribution of D₁ and D₂ are not too far from one another. For example, if there are three features (f₁, f₂ and f₃) and a target (y), with f₁ as the sensitive attribute, then the distribution of (f₂, f₃, Y)_{D1} is compared with the distribution of (f₂, f₃, Y)_{D2}.

After training the model, the trained model is utilized for imputing missing data in the dataset (e.g., missing values in the data samples of the dataset for a sensitive group) in the presence of data quality disparity as discussed below in connection with FIG. 5.

FIG. 5 is a flowchart of a method 500 for identifying the missing values to be imputed in the dataset based on maximizing the fairness metric and accuracy of the trained model in accordance with an embodiment of the present disclosure.

Referring to FIG. 5, in conjunction with FIGS. 1-4, in step 501, identifying engine 202 of missing data identifier 101 formulates an optimization problem of imputing the missing values in the dataset as a black-box optimization problem with an objective of jointly maximining both the fairness metric and an accuracy of the trained model (machine learning model).

As discussed above, a “fairness metric,” as used herein, refers to a measure that enables a user to detect the presence of bias in the data or model. “Bias,” in connection with the fairness metric, as used herein, refers to a preference of one group, such as a sensitive group, over another group, implicitly or explicitly. Examples of fairness metrics include, but not limited to, disparate impact, statistical parity difference, equal opportunity difference, etc. For instance, fairness may be maximized by minimizing the disparate impact among sensitive groups. “Accuracy,” as used herein, refers to a fraction of the predictions that the model was correct. For example, accuracy may correspond to the number of correct predictions/total number of predictions. Missing values to be imputed in the dataset may then be identified based on maximizing the fairness metric and the accuracy of the model.

“Black box optimization,” as used herein, refers to a problem setup in which an optimization algorithm is supposed to optimize an objective function through a so-called black-box interface. For example, the algorithm may query the value f(x) for a point x, but it does not obtain gradient information, and in particular, it cannot make any assumptions on the analytic form of f (e.g., being linear or quadratic). Such an objective function may be thought as being wrapped in a black box. The goal of optimization is to find an as good as possible value f(x) within a predefined time, often defined by the number of available queries to the black box.

In one embodiment, the black-box optimization problem is solved by identifying engine 202 using a black-box optimization technique, such as reinforcement learning, to solve the optimization problem using the trained model to impute missing values.

In one embodiment, the missing values are modeled as hyperparameters in the trained model. Hyperparameters, as used herein, refer to parameters whose values control the learning process and determine the values of the model parameters that a learning algorithm ends up learning. In one embodiment, identifying engine 202 identifies the missing values to be imputed in the dataset (e.g., data samples of the dataset for the sensitive group) by solving the black-box optimization problem with the missing values modeled as hyperparameters using various software tools, including, but not limited to, Google® Vizier, NOMAD®, etc.

In step 502, identifying engine 202 of missing data identifier 101 identifies the missing values to be imputed in the dataset based on maximizing the fairness metric and the accuracy of the model (trained model).

As stated above, in one embodiment, identifying engine 202 identifies the missing values to be imputed in the dataset (e.g., data samples of the dataset for the sensitive group) in the presence of data quality disparity by solving the optimization problem using the black-box optimization technique to identify the missing values to be imputed in the dataset which maximizes the fairness metric and the accuracy of the model.

In one embodiment, identifying engine 202 identifies the missing values to be imputed in the dataset (e.g., data samples of the dataset for the sensitive group) in the presence of data quality disparity by selecting one of the possible imputation algorithms to identify the missing values to be imputed in the dataset which maximizes the fairness metric and the accuracy of the model. An imputation algorithm, as used herein, refers to an algorithm that substitutes the missing data with a different value while retaining the majority of the dataset's data and information. Examples of such imputation algorithms include, but not limited to, next or previous value, k-nearest neighbors, maximum or minimum value, missing value prediction, most frequent value, average or linear interpolation, (rounded) mean or moving average or median value, fixed value, etc.

In this manner, the disparity of the data quality in machine learning datasets involving missing data among sensitive groups is effectively handled by training a model to be both bias aware and data quality aware. For example, the principles of the present disclosure identify the missing values be imputed in the dataset (e.g., data samples of the dataset for the sensitive group) in the presence of data quality disparity by solving the optimization problem using the black-box optimization technique to identify the missing values to be imputed in the dataset which maximizes the fairness metric and the accuracy of the machine learning model.

Furthermore, the principles of the present disclosure improve the technology or technical field involving the disparity of data quality in machine learning datasets. As discussed above, data quality, including completeness of the data, may vary in datasets, such as machine learning datasets. In particular, the data quality of such datasets may vary across different “sensitive groups.” A “sensitive group,” as used herein, refers to variables or participants (e.g., privileged versus unprivileged) for which the collected data (e.g., health insurance coverage) may vary. At times, certain sensitive groups may have a greater amount of missing data in the dataset than other sensitive groups. For example, an unprivileged group (e.g., low income participants) may have a greater amount of missing data than a privileged group (e.g., high income participants). Hence, the unprivileged group may be said to have poor quality data; whereas, the privileged group may be said to have high quality data. Typically, when processing data for machine learning, the rows of data that includes missing values are removed so as to provide the highest quality of data for machine learning. Unfortunately, by removing such low quality data, the sensitive group (e.g., low income participants) associated with such data may be underrepresented or even eliminated from being represented by the dataset. As a result, the machine learning model may learn incorrect representations from the dataset. For example, the original dataset may contain missing values disproportionately for certain sensitive groups (e.g., low income participants) thereby having what is said to be a “bias” with respect to such sensitive groups. “Bias” refers to having the results not being able to be generalizable, such as for the sensitive group, since the data comes from an unrepresentative sample. By removing such low quality data, such as removing the rows containing missing values, the data is said to be “cleaned.” However, the cleaned data is not only biased with respect to such sensitive groups, but may even be more biased to such sensitive groups since data pertaining to such sensitive groups was removed. When such cleaned data is used to train the machine learning model, the machine learning model may still learn incorrect representations with respect to the original uncleaned data even if the model is trained using machine learning techniques that attempt to remove bias from the cleaned data. Hence, there is not currently a means for effectively handling the disparity of data quality in machine learning datasets where the quality of data or the amount of missing data varies among sensitive groups.

Embodiments of the present disclosure improve such technology by formulating an optimization problem of imputing the missing values in the dataset with a presence of data quality disparity as a black-box optimization problem with an objective of jointly maximining both the fairness metric and an accuracy of the model (machine learning model) trained to identify the missing values to be imputed in the dataset for the sensitive group. Missing values to be imputed in the dataset may then be identified based on maximizing the fairness metric and the accuracy of the model. In one embodiment, the missing values to be imputed in the dataset (e.g., data samples of the dataset for the sensitive group) in the presence of data quality disparity are identified by solving the optimization problem using a black-box optimization technique (e.g., reinforcement learning) which maximizes the fairness metric and the accuracy of the model. In one embodiment, one out of the possible imputation algorithms is selected to identify the missing values to be imputed in the dataset which maximizes the fairness metric and the accuracy of the model. An imputation algorithm, as used herein, refers to an algorithm that substitutes the missing data with a different value while retaining the majority of the dataset's data and information. Examples of such imputation algorithms include, but not limited to, next or previous value, k-nearest neighbors, maximum or minimum value, missing value prediction, most frequent value, average or linear interpolation, (rounded) mean or moving average or median value, fixed value, etc. In this manner, the disparity of the data quality in machine learning datasets involving missing data among sensitive groups is effectively handled. Furthermore, in this manner, there is an improvement in the technical field involving the disparity of data quality in machine learning datasets.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for imputing missing data in the presence of data quality disparity, the method comprising:
formulating an optimization problem of imputing missing values in a dataset as a black-box optimization problem with an objective of jointly maximizing both a fairness metric and an accuracy of a model; and
identifying missing values to be imputed in said dataset based on maximizing said fairness metric and said accuracy of said model.

2. The method as recited in claim 1 further comprising:
imputing missing values in data samples of said dataset for each sensitive group in said dataset separately.

3. The method as recited in claim 2 further comprising:
training said model using sample weights corresponding to said data samples with said imputed missing values jointly weighed based on data quality and data bias.

4. The method as recited in claim 3, wherein said sample weights are used to weigh terms in a loss function of said model.

5. The method as recited in claim 1 further comprising:
selecting one of a plurality of imputation algorithms to identify said missing values to be imputed in said dataset which maximizes said fairness metric and said accuracy of said model.

6. The method as recited in claim 1 further comprising:
solving said optimization problem using a black-box optimization technique to identify said missing values to be imputed in said dataset which maximizes said fairness metric and said accuracy of said model.

7. The method as recited in claim 6, wherein said black-box optimization technique comprises reinforcement learning.

8. A computer program product for imputing missing data in the presence of data quality disparity, the computer program product comprising one or more computer readable storage mediums having program code embodied therewith, the program code comprising programming instructions for:
formulating an optimization problem of imputing missing values in a dataset as a black-box optimization problem with an objective of jointly maximizing both a fairness metric and an accuracy of a model; and
identifying missing values to be imputed in said dataset based on maximizing said fairness metric and said accuracy of said model.

9. The computer program product as recited in claim 8, wherein the program code further comprises the programming instructions for:
imputing missing values in data samples of said dataset for each sensitive group in said dataset separately.

10. The computer program product as recited in claim 9, wherein the program code further comprises the programming instructions for:
training said model using sample weights corresponding to said data samples with said imputed missing values jointly weighed based on data quality and data bias.

11. The computer program product as recited in claim 10, wherein said sample weights are used to weigh terms in a loss function of said model.

12. The computer program product as recited in claim 8, wherein the program code further comprises the programming instructions for:
selecting one of a plurality of imputation algorithms to identify said missing values to be imputed in said dataset which maximizes said fairness metric and said accuracy of said model.

13. The computer program product as recited in claim 8, wherein the program code further comprises the programming instructions for:
solving said optimization problem using a black-box optimization technique to identify said missing values to be imputed in said dataset which maximizes said fairness metric and said accuracy of said model.

14. The computer program product as recited in claim 13, wherein said black-box optimization technique comprises reinforcement learning.

15. A system, comprising:
a memory for storing a computer program for imputing missing data in the presence of data quality disparity; and
a processor connected to said memory, wherein said processor is configured to execute program instructions of the computer program comprising:
formulating an optimization problem of imputing missing values in a dataset as a black-box optimization problem with an objective of jointly maximizing both a fairness metric and an accuracy of a model; and
identifying missing values to be imputed in said dataset based on maximizing said fairness metric and said accuracy of said model.

16. The system as recited in claim 15, wherein the program instructions of the computer program further comprise:
imputing missing values in data samples of said dataset for each sensitive group in said dataset separately.

17. The system as recited in claim 16, wherein the program instructions of the computer program further comprise:
training said model using sample weights corresponding to said data samples with said imputed missing values jointly weighed based on data quality and data bias.

18. The system as recited in claim 17, wherein said sample weights are used to weigh terms in a loss function of said model.

19. The system as recited in claim 15, wherein the program instructions of the computer program further comprise:
selecting one of a plurality of imputation algorithms to identify said missing values to be imputed in said dataset which maximizes said fairness metric and said accuracy of said model.

20. The system as recited in claim 15, wherein the program instructions of the computer program further comprise:
solving said optimization problem using a black-box optimization technique to identify said missing values to be imputed in said dataset which maximizes said fairness metric and said accuracy of said model.
